(19) United States
(12) Patent Application Publication
(10) Pub. No.: US 2007/0095748 A1
(43) Pub. Date: May 3, 2007

(54) Pore size controlled materials for wet/dry filtration

(76) Inventors: Michael Gerakios, Avoca Beach (AU); Michael Neate, Copacabana (AU)

Correspondence Address: FROMMER LAWRENCE & HAUG, 745 FIFTH AVENUE- 10TH FL., NEW YORK, NY, 10151, US

(21) Appl. No.: 11/265,370

(22) Filed: Nov. 2, 2005

(51) Int. Cl. B01D 39/00

(52) U.S. Cl. 210/503; 210/510.1; 427/245

(57) ABSTRACT

A filter media, and method of making, and a method of controlling pore size in a filter media, wherein the filter media includes a filter structure and a foam material to control pore size, such that the use of coarse fibers to create the filter structure may be utilized.

### FIELD OF THE INVENTION

The invention is directed to filter media which comprise of pore size controlled surfaces which are formed by applying a foam to a fiber matrix, base filter structure, or web surface penetrating there within.

### BACKGROUND OF THE INVENTION

Filters have wide commercial applications and utility in industries including but not limited to alumina, wood, plastic, steel, paper, glass, cement, chemical processing, waste incineration, power generation, smelting and mining. Filters generally involve the use of a filter media. Filter media can include but is not limited to: needled felt, nonwoven material, woven material, knitted fabric, fiberglass and/or metal fabrics, foam coated fabrics or a laminate of at least two of these structures. The filter media may or may not require a supporting structure. For example, filters made from a woven or nonwoven textile material for particulate filtration from gas streams are often supported by way of cages made from metal or other suitable material. In operation, the filter removes particulate matter from a gas stream, which flows through the filter. The particulate accumulates on the filter and is subsequently collected.

Filters can take on a variety of shapes. For example, as set forth in U.S. Pat. No. 5,858,039 the disclosure of which is incorporated herein by reference, a filter bag is shown having a star shape. The filter support, or cage, also has a star shape about which the filter media is supported. The star shape of the filter media provides an increased filtering surface area compared to that of a cylindrical filter bag. In addition, the filters can be, but are not limited to, the following configurations: (i) a circular or cylindrical shape; (ii) an oblong shape or oval shape; (iii) an x-shape, y-shape, or any star shape defined as a shape with a plurality of pleats; or (iv) any shape with a plurality of sides such as a triangle, quadrilateral, pentagon, hexagon, septagon, octagon, nonagon, decagon, or similar.

Conventional dry and wet filter materials are known in the art with the fibers of a dry filter material being in range of about 1.5 to about 3.0 denier and wet filter material having a range of about 3.0 to about 6.0 denier. The size of the fibers helps to define the porosity of the filter media and thus its filtering ability. Typically, the smaller the fibers used in the making of the filter media, the smaller the pore size.

Attempts have been made to control pore size through the use of foam coatings that are applied to fabrics or nonwoven materials in different applications. For example, U.S. Pat. No. 6,071,602 refers to an article having a cured material positioned within the web to control the effective pore size of the web. But, these attempts have been largely unsuccessful because the surface with foam as the coating had poor resistance to abrasion and disappeared after a short time in use. Further, without any support throughout the web structure of a filter bag, there are questions regarding durability and pore size integrity if such teachings were to be applied to filters.

Regardless of the shape or size of the filter media or bag (sometimes used interchangeably herein), it is desirable that the filter exhibit toughness and abrasion resistance to make them suitable for long term industrial use. Likewise, it is desirable for the filter media to maintain the integrity of the pore size during long term use.

It is known that when using fiber to form the filter media surface, even when one fiber diameter is used, e.g. 6 denier (6.7 dtex), that through the processing of creating the fiber web and attaching it through/into the filter form or substrate that fiber mixing and orientations lead to a broad range of pore sizes, that is the spacing between the fibers. The “target pore diameter” is usually the center of this distribution range. Obviously, some pores are smaller than others and can cause operational problems such as plugging or high pressure during operation. Other pores are larger than desirable causing a loss in particulate filtering efficiency, since particles pass through such pores. Therefore, use of coarser fibers of larger cross-sections is desirable, but will not yield good filtering efficiency in and of itself. However, the use of well designed foam coatings which can be designed with a narrow range of pore size, will result in a more desirable filter medium.

Therefore, there is a need in the art for a long lasting, abrasion resistant filter media and media material which can have its pore size controlled and maintain the integrity of the pore size.

### SUMMARY OF THE INVENTION

It on object of the present invention to provide a filter media having a pore size determined by a coating material applied thereto whilst allowing for the use of coarser fibers than that heretofore utilized.

Another object of the invention is to provide filter media which is suitable for wet/dry filtration.

Another object of the invention is to provide for a method of controlling the pore diameter by controlling the attributes of a coating material applied thereto.

One aspect of the present invention is a filter media including a filter structure of coarse fibers which are coarser than 6.0 denier, and a foam material which controls the pore size of the filter media.

Another aspect of the present invention is a method of making a filter media including the steps of providing a filter structure of coarse fibers which are coarser than 6.0 denier, providing a foam material, and coating the base filter structure with the foam material. The foam material resides primarily beneath the surface of the filter structure but is contiguous to the surface and the foam material controls the pore size of the filter media. The method includes a further step of curing the foam material Yet a further aspect of the present invention is a method of controlling the pore diameter of a filter media including the steps of pre-determining a pore diameter, providing a filter structure comprised of coarse fibers of between 6.0 and 200 denier, and providing a foam material formed of a mixture of a blend of two aqueous acrylic emulsions of differing glass transition temperatures or a blend of an aqueous acrylic emulsion with a polyurethane emulsion, a filler component, a foaming agent, a foam stabilizing agent, a thickening agent, a pH controlling agent, and a cross-linking (curing) agent. The method also includes steps of adjusting the amount of thickening agent, foaming agent and foam stabilizing agent to obtain the pre-determined pore diameter in the foam to form a modified foam mixture, applying the modified foam material to the filter structure, and curing the modified foam mixture to control the filter pore size.

The various features of novelty which characterize the invention are pointed out in particularity in the claims annexed to and forming a part of this disclosure. For a better understanding of the invention, its operating advantages and specific objects attained by its uses, reference is made to the accompanying descriptive matter in which preferred embodiments of the invention are illustrated.

Thus by the present invention, its objects and advantages will be realized, the description of which should be taken in conjunction with the following detailed description.

### DETAILED DESCRIPTION

The present invention is directed to the enhancement of filter media or bags by controlling the pore sizes of the filter media through application of coating material to the fibrous structure.

Traditionally, the pore size of filter media has been controlled by using smaller sized fibers in a fiber matrix, base filter structure or web surface to achieve the desired porosity. As a result most filter media typically employ fibers of between 1.5 and 6.0 denier (e.g., 6.7 dtex) According to one aspect of the present invention many of the problems in the art associated with pore size control for dry and wet filter base structure can be overcome by applying the foam to effect subsurface penetration of coarser structures.

In one preferred embodiment, the foam is formed of a two different acrylic emulsions or a mixture of an acrylic emulsion and a polyurethane emulsion. The foam applied onto the surface of the fibrous filter material and penetrates into the fiber matrix. The use of the foam allows for use of coarser fibers (for example, fibers coarser than 6.0 denier up to 200 denier) than those conventionally used as dry or wet filter fiber material. The dry or wet filter base structures and the corresponding filter media or bags manufactured therefrom exhibit improved resistance to abrasion and are suitable for maintaining the integrity of the desired pore size.

The pore size can be controlled by the use of foam produced, for example, from a blend of acrylic emulsion(s) and/or an acrylic emulsion and a polyurethane emulsion. The foam resides primarily beneath the surface of the filter fiber matrix, i.e. the surface exposed to the filtrate solution, and is contiguous to the surface as well.

In one embodiment of the invention, the foam used to coat or impregnate is formed from, for example, a mixture which comprises:
(a) a blend of two aqueous acrylic emulsions of differing glass transition temperatures; or a blend of an aqueous acrylic emulsion with a polyurethane emulsion;
(b) a filler component;
(c) a foaming agent;
(d) a foam stabilizing agent;
(e) a thickening agent;
(f) a pH controlling agent; and
(g) a cross-linking (curing) agent;

The filter media of the invention may be used to create a filter bag which typically comprises a woven substrate with a needle punched batt of fibers attached thereto. This needle punched batt of fibers creates the filter media as referred to herein. It can be constructed as a nonwoven filter media as is commonly known in the art, but utilizing coarse fibers in combination with a foam as described herein. For example, in one embodiment of the present invention the fiber matrix, base filter structure or web surface of the filter media is made up of fibers having a coarseness of about 15 to about 70 denier. In another embodiment of the invention, the fibers have a coarseness of about 40 to about 70 denier. Moreover and most advantageously, the present invention may be used with fibers up to 200 denier.

In another embodiment of the invention, the pore diameter can be controlled by controlling the viscosity and the shear of the emulsions during mixing. By controlling these variables of the emulsion the resulting pore diameter can be created and controlled. This method, for example, comprises:
(a) pre-determining a pore diameter;
(b) adjusting the amount of thickening agent, foaming agent and foam stabilizing agent to obtain the pre-determined pore diameter
(c) applying the modified foam mixture to the filter surface; and
(d) curing the modified foam mixture.

This invention surprisingly is able to use coarser fibers to construct a filter media, which is both resistant to abrasion and also is able to control the pore diameter while maintaining that pore diameter for long periods of time.

Having thus described in detail various embodiments of the present invention, it is to be understood that the invention defined by the above paragraphs is not to be limited to particular details set forth in the above description as many apparent variations thereof are possible without departing from the spirit or scope of the present invention.

What is claimed is:

1. A filter media comprising:
a filter structure comprised of coarse fibers which are coarser than 6.0 denier; and
a foam material which controls the pore size of the filter media.

2. The filter media of claim 1 wherein the foam material comprises:
(a) a blend of two aqueous acrylic emulsions of differing glass transition temperatures; or a blend of an aqueous acrylic emulsion with a polyurethane emulsion;
(b) a filler component;
(c) a foaming agent;
(d) a foam stabilizing agent;
(e) a thickening agent;
(f) a pH controlling agent; and
(g) a cross-linking (curing) agent.

3. The filter media of claim 1, wherein the filter structure comprises fibers of about 15 to about 70 denier.

4. The filter media of claim 3, wherein the filter structure comprises fibers of about 40 to 70 denier.

5. The filter media of claim 1, wherein the filter structure comprises fibers of greater than 6.0 denier up to about 200 denier.

6. The filter media of claim 1, wherein the pore size controlling foam is applied to a surface of the filter structure, and resides primarily beneath the surface and is contiguous to the surface.

7. A method of making a filter media comprising:
providing a filter structure of coarse fibers which are coarser than 6.0 denier;
providing a foam material;
coating the base filter structure with the foam material, wherein the foam material resides primarily beneath the surface of the filter structure and is contiguous to the surface and wherein the foam material controls a pore size of the filter media; and
curing the foam material.

8. The method of claim 7 wherein the foam material is formed of a mixture of a blend of two aqueous acrylic emulsions of differing glass transition temperatures or a blend of an aqueous acrylic emulsion with a polyurethane emulsion, a filler component, a foaming agent, a foam stabilizing agent, a thickening agent, a pH controlling agent, and a cross-linking (curing) agent.

9. A method of controlling the pore diameter of a filter media comprising:
pre-determining a pore diameter;
providing a filter structure comprised of coarse fibers of between 6.0 and 200 denier;
providing a foam material formed of a mixture of a blend of two aqueous acrylic emulsions of differing glass transition temperatures or a blend of an aqueous acrylic emulsion with a polyurethane emulsion, a filler component, a foaming agent, a foam stabilizing agent, a thickening agent, a pH controlling agent, and a cross-linking (curing) agent;
adjusting the amount of thickening agent, foaming agent and
foam stabilizing agent to obtain the pre-determined pore diameter in the foam to
form a modified foam mixture;
applying the modified foam material to the filter structure; and
curing the modified foam mixture to control the filter pore size.
